(19) United States
(12) Patent Application Publication
(10) Pub. No.: US 2008/0246632 A1
(43) Pub. Date: Oct. 9, 2008

(54) Aviation Rf Receiver Front End Multiplexing Method and Apparatus

(75) Inventors: Ovidiu Gabriel Vlad, Naperville, IL (US); Lawrence Carl Spaete, Naperville, IL (US); Alfred Robert Zantow, St. Charles, IL (US)

Correspondence Address: FITCH EVEN TABIN AND FLANNERY, 120 SOUTH LA SALLE STREET, SUITE 1600, CHICAGO, IL, 60603-3406, US

(73) Assignee: EMBEDDED CONTROL SYSTEMS, Lisle, IL (US)

(21) Appl. No.: 11/695,921

(22) Filed: Apr. 3, 2007

(51) Int. Cl. G08B 21/00

(52) U.S. Cl. 340/945; 340/539.1; 340/961; 340/982

(57) ABSTRACT

A group multiplexed output (208) operably couples to each unique intermediate frequency received signal output as corresponds to a plurality of aviation radio frequency receiver front ends (502). By one approach, this can comprise, in particular, multiplexing, in frequency, each of the discrete received signal outputs for each of the plurality of aviation radio frequency receiver front ends with one another. By one approach, each such aviation radio frequency receiver front end is configured and arranged to receive radio frequency signals for a corresponding different radio frequency platform (as may each correspond, for example, to a different aviation operational purpose).

### RELATED APPLICATIONS

This invention relates generally to two co-pending patent applications as were filed on even date herewith as follows:

AVIATION APPLICATION SETTING ANTENNA ARRAY METHOD AND APPARATUS bearing attorney's docket number 8462/90221; and

INTEGRATED AVIATION RF RECEIVER FRONT END AND ANTENNA METHOD AND APPARATUS bearing attorney's docket number 8462/90223;

the contents of which are fully incorporated herein by this reference.

### TECHNICAL FIELD

This invention relates generally to aircraft and more particularly to wireless communications in an aviation application setting.

### BACKGROUND

Modern aircraft typically include a variety of wireless reception and/or transmission platforms, many of which are primarily or even exclusively intended for aviation purposes. Some examples include, but are certainly not limited to, global positioning system receivers, VOR transceivers, marker beacon receivers, aircraft transponder transceivers, ILS receivers, ELT transmitters, TCAS receivers, ADS-B receivers, data link weather receivers, and two-way voice communications transceivers of various kinds (including but not limited to terrestrial cellular telephony, satellite-based communications, VHF transceivers, and so forth), to note but a few relevant examples.

In general, each of these platforms comprises a discrete and independent entity. While an occasional exception occurs (such as a combined cellular telephone and a GPS receiver), each such platform typically comprises a separate radio having it's own dedicated antenna, RF front end, RF back end, and user interface. For the most part such radios are typically either mounted in a corresponding cabinet in the cockpit or comprise discrete cards (comprising the RF front and back end sections) that are mounted in a shared user interface platform. The various antennas for these cockpit-disposed radios are typically mounted in various external locations external to the fuselage of the aircraft.

Such prior art practices are successful with respect to tending to ensure the availability of a successfully operable plurality of radio platforms. There remain, nevertheless, a number of unmet needs. Volume and weight both comprise important considerations for avionics equipment, with both contributing in part to the carrying capacity of the aircraft and the cost of operating that aircraft. Present approaches tend to represent both considerable weight and space requirements. Design for maintainability also comprises an important consideration in an aviation application setting. Present approaches can present challenges in this regard both respect to ease and cost of effecting necessary repairs.

### BRIEF DESCRIPTION OF THE DRAWINGS

The above needs are at least partially met through provision of the aviation RF receiver front end multiplexing method and apparatus described in the following detailed description, particularly when studied in conjunction with the drawings, wherein:

FIG. 1 comprises a flow diagram as configured in accordance with various embodiments of the invention;

FIG. 2 comprises a block diagram as configured in accordance with various embodiments of the invention;

FIG. 3 comprises a plan schematic view as configured in accordance with various embodiments of the invention;

FIG. 4 comprises a perspective detail view as configured in accordance with various embodiments of the invention;

FIG. 5 comprises a side elevational sectioned view as configured in accordance with various embodiments of the invention;

FIG. 6 comprises a series of frequency usage graphs as configured in accordance with various embodiments of the invention; and

FIG. 7 comprises a top plan view as configured in accordance with various embodiments of the invention.

Skilled artisans will appreciate that elements in the figures are illustrated for simplicity and clarity and have not necessarily been drawn to scale. For example, the dimensions and/or relative positioning of some of the elements in the figures may be exaggerated relative to other elements to help to improve understanding of various embodiments of the present invention. Also, common but well-understood elements that are useful or necessary in a commercially feasible embodiment are often not depicted in order to facilitate a less obstructed view of these various embodiments of the present invention. It will further be appreciated that certain actions and/or steps may be described or depicted in a particular order of occurrence while those skilled in the art will understand that such specificity with respect to sequence is not actually required. It will also be understood that the terms and expressions used herein have the ordinary meaning as is accorded to such terms and expressions with respect to their corresponding respective areas of inquiry and study except where specific meanings have otherwise been set forth herein.

### DETAILED DESCRIPTION

Generally speaking, pursuant to these various embodiments, a group multiplexed output can operably couple to each unique intermediate frequency received signal output as corresponds to a plurality of aviation radio frequency receiver front ends. By one approach, this can comprise, in particular, multiplexing, in frequency, each of the discrete received signal outputs for each of the plurality of aviation radio frequency receiver front ends with one another. By one approach, each such aviation radio frequency receiver front end is configured and arranged to receive radio frequency signals for a corresponding different radio frequency platform (as may each correspond, for example, to a different aviation operational purpose).

These teachings will readily accommodate intermediate frequency received signal outputs of different bandwidths. The number of aviation radio frequency receiver front ends so multiplexed can vary with the needs of the application setting but can comprise, for example, at least three, six, twelve, or more such platforms. So configured, these teachings are readily scaled such that a large number of aviation radio frequency receiver front ends can be similarly accommodated. This, in turn, permits a correspondingly large number of such platforms to be provided in close proximity to one another and even as a substantially or fully physically integrated platform. These teachings are also readily leveraged through close installed proximity to the corresponding antennas for such platforms. It will further be appreciated that such teachings will accommodate installation of such platforms in other than a cockpit.

These teachings facilitate reduced space requirements as well as reduced weight requirements as compared to typical prior art approaches in aviation application settings. This approach also facilitates ease of maintenance and will further be seen to permit further improvements with respect to accommodating and leveraging new and unique overall aviation radio architectures.

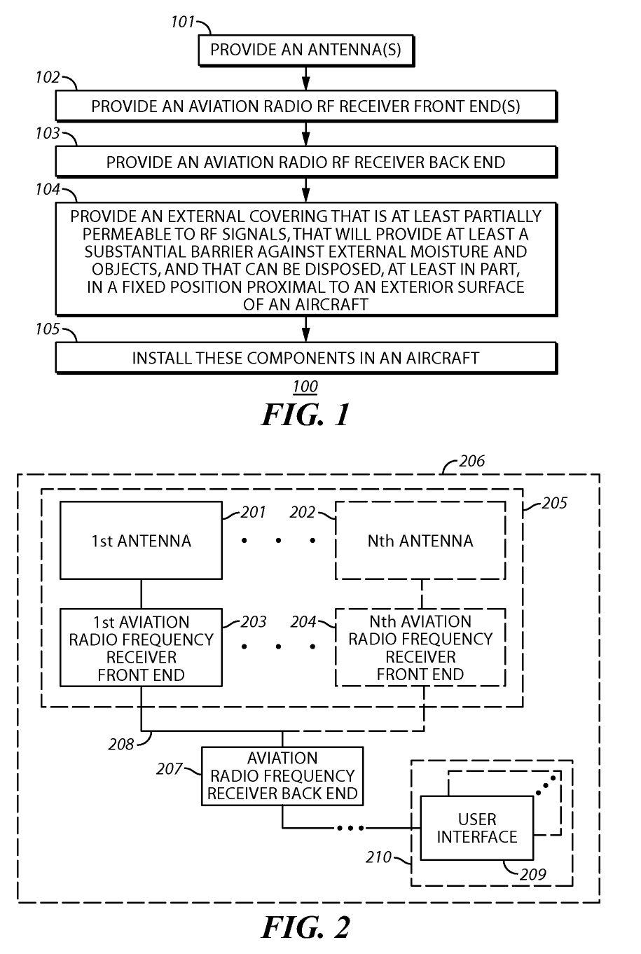

These and other benefits may become clearer upon making a thorough review and study of the following detailed description. Referring now to the drawings, and in particular to FIG. 1, an illustrative process 100 suitable to represent at least certain of these teachings will be described. This process 100 provides first for provision 101 of one or more antennas as shown in FIG. 2. This antenna(s) 201 may be configured and arranged to receive radio frequency (RF) signals for a corresponding radio frequency platform (or platforms in the case of multiple antennas) as described in more detail below. When this step comprises providing a plurality of antennas 201, 202 (where “N” as shown in FIG. 2 will be understood to refer to any integer greater than one) such as, for example, four antennas, these antennas may be electrically discrete from one another.

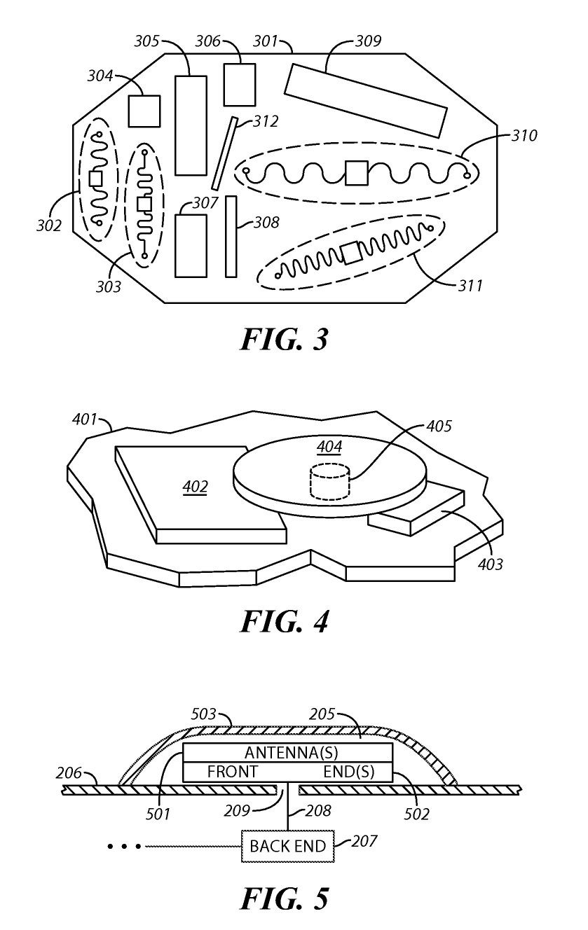

By one approach, and referring now momentarily to FIG. 3, this can comprise providing a plurality of antennas 302 through 311 that share a common component substrate 301 comprised at least in part, for example, of printed wiring board material or the like. One or more of these antennas can comprise discrete microstrip patch antennas as suggested in this illustration. The manufacture and use of such patch antennas is well known in the art and requires no further elaboration here. So configured, these antennas can each have a corresponding integral ground plane and, if desired, two or more of these integral ground planes can be electrically coupled in common with one another. By one approach, a multi-layer printed wiring board 301 that serves as the mounting substrate for such antennas can include one or more layers that serve as such ground planes. As with patch antennas themselves, the formation and use of such a ground plane is also well known in the art and requires no additional description here.

By one approach, each such antenna can share a same plane as each remaining antenna (as when all of the antennas are formed on a shared planar surface). These teachings will also accommodate, however, the use of differing planes to contain part or all of one or more such antennas. To illustrate this point, and referring momentarily to FIG. 4, a given substrate 401 can support, in a first plane, two patch antennas 402 and 403 while a third patch antenna 404 rests atop a pedestal 405 that raises the third patch antenna 404 to a plane above that which corresponds to the substrate 401. By this configuration, as shown, portions of two or more of the patch antennas are able to occupy a same footprint area. In this specific illustrative example, two of the patch antennas 402 and 403 are disposed, in part, beneath the third patch antenna 404.

These teachings will also accommodate a relatively dense population of such antennas notwithstanding their different aviation-related purposes and differing reception and/or transmission bands of interest. As one illustrative example in this regard, while the substrate 301 may be approximately only ten inches in length and approximately five inches in width, ten such antennas serving aviation purposes can be suitably and satisfactorily mounted in accordance with these teachings. In such an example, the following antennas can serve and correspond to the following indicated aviation purposes:

First antenna 302—VHF Com 20 W transmit 119-135 Mhz AM (vertically polarized);

Second antenna 303—Transponder high power transmit antenna (vertically polarized);

Third antenna 304—GPS reception;

Fourth antenna 305—400 Mhz SATCOM;

Fifth antenna 306—WX (or WSI) weather satellite reception;

Sixth antenna 307—Transponder receiver;

Seventh antenna 308—Cellular telephony (code division multiple access);

Eighth antenna 309—332 Mhz glideslope reception;

Ninth antenna 310—108-118.5 Mhz VOR/LOC reception; and

Tenth antenna 311—75 Mhz marker beacon reception.

Referring again to FIG. 3, it may be useful in some aviation application settings to configure such antennas in a manner that tends to provide some electro/magnetic isolation therebetween. By one approach, this can comprise intentionally orienting at least some of the antennas with respect to one another in a manner that increases such isolation. The antennas denoted by reference numerals 309, 310, and 311 have such an orientation.

By another approach, used alone or in conjunction with that mentioned above, electro/magnetic shields can be disposed between at least two such antennas to increase the electro/magnetic isolation therebetween. Such a shield 312 appears in FIG. 3 and serves, in this illustrative example, to aid in further isolating the antenna denoted by reference numeral 305 from the antenna denoted by reference numeral 310. Such a shield can be comprised, in part or in whole, of metal such as aluminum, copper, or gold and can have a shape and dimensions as may best serve the needs of a given application setting. (FIG. 3 illustrates only one such shield; those skilled in the art will recognize and understand that any number of such shields can be applied and that only one is shown here for the sake of simplicity and clarity.)

In the examples presented above, each antenna is configured and arranged by design and intent to receive and/or transmit primarily in service of a single band of interest and its corresponding purpose and functionality. If desired, however, one or more of these antennas can comprise a broadband antenna that is configured and arranged to receive RF signals for a corresponding plurality of different RF platforms.

Referring again to FIG. 1, this process 100 then provides for provision 102 of one or more aviation radio RF receiver front ends. As used herein, “aviation radio RF receiver front end” will be understood to refer to that portion of an RF receiver that extends from an antenna input through an intermediate frequency section that provides as output an intermediate frequency signal as versus a baseband representation of the transmitted content. As illustrated in FIG. 2, that antenna input will be configured and arranged to operably couple to a corresponding one of the previously mentioned antennas 201, 202 such that each aviation radio RF receiver front end 203, 204 will receive its corresponding RF signals from a corresponding one of the antennas. (Those skilled in the art will recognize and understand that two or more such aviation radio RF receiver front ends may couple to a shared antenna when that shared antenna comprises a broadband antenna as described above.)

This aviation radio RF receiver front end (or front ends) is configured and arranged to receive RF signals for a corresponding different RF platform and can comprise any of a wide variety of aviation purpose-based platforms that each serve a corresponding different aviation operational purpose. Some examples include, but are not limited to:

a global positioning system receiver;

a very high frequency (VHF) two-way voice communications transceiver;

a marker beacon receiver;

a VHF Omni-directional Range (VOR) receiver;

an aircraft transponder transceiver;

an Instrument Landing System (ILS) receiver comprised of a localizer receiver and a glideslope receiver;

an aircraft emergency locator transmitter (ELT);

an aircraft satellite communications receiver (SatCom);

a Traffic Alert Collision Avoidance System (TCAS) receiver;

an Automatic Dependent Surveillance-Broadcast (ADS-B) receiver;

a data link weather receiver;

a cellular telephony transceiver; and/or

a satellite-based commercial broadcast receiver.

As already noted above, there can be any number of such aviation RF receiver front ends. For example, pursuant to one application setting, there may be three such aviation RF receiver front ends. For another application setting, there may be six such aviation RF receiver front ends while for yet another application setting, there may be twelve such aviation RF receiver front ends. Those skilled in the art will recognize and understand that such examples are intended to serve only in an illustrative context and are not offered as an exhaustive listing of all possible examples in this regard.

By one approach, the aforementioned antenna(s) 201, 202 and aviation RF receiver front end(s) 203, 204 can all be configured and arranged to be disposed during use at least partially external 205 to an external periphery of an aircraft fuselage 206. If desired, these components can further all be so disposed in close physical proximity to one another (as when, for example, such components are all located within only a very few inches or fractions of an inch of one another). To illustrate, and referring momentarily to FIG. 5, a plurality of antennas 501 as described above along with a plurality of aviation RF receiver front ends 502 can be mounted exterior 205 to an aircraft fuselage 206. By one approach, if desired, both the antennas 501 and the aviation RF receiver front ends 502 can be mounted on opposing sides of a shared multi-layer printed wiring board. By another approach, such components can be mounted on separate substrates, which substrates are themselves combined together as a shared physical form factor.

Those skilled in the art will recognize and appreciate that, although comprising a very different approach to that usually seen in an aviation application setting, such teachings serve to greatly reduce the volume and weight requirements that would otherwise typically be associated with a plurality of aviation radio platforms. Maintenance and repair operations are also greatly simplified via such an architectural approach.

Referring again to FIGS. 1 and 2, these teachings then provide for provision of an aviation RF receiver back end 207. As used herein, the expression “aviation RF receiver back end” will be understood to refer to that portion of a radio that receives an intermediate frequency signal and that further processes that signal to yield baseband, demodulated, and recovered bearer content. Such functionality can be provided, in whole or in part, through use of one or more appropriately programmed digital signal processing sections that ultimately output demodulated content as corresponds to received wireless signals. As the present teachings are not overly sensitive to the selection of any particular approach in this regard, for the sake of brevity and the preservation of clarity additional elaboration in this regard will not be provided here.

This aviation RF receiver back end 207 can also be disposed closely proximal to the aforementioned aviation RF receiver front ends though, as illustrated in FIG. 5, the aviation RF receiver back end may be disposed within the fuselage 206 of the aircraft rather than external thereto for many application settings. By one approach, and similar to the previously described antenna array, these aviation radio RF receiver front ends may be closely packed and can essentially comprise an integrated physical assembly where appropriate. In either case, as desired, the aviation RF receiver front end(s) and back end(s) can comprise a single integrated sandwich structure as suggested by FIG. 5.

As mentioned above, in many application settings there can be a plurality of aviation RF receiver front ends. In such a case, and if desired, there can be a corresponding plurality of aviation RF receiver back ends. These teachings will also accommodate, however, the use of a fewer number of aviation RF receiver back ends. As one illustrative example in this regard, a single aviation RF receiver back end can be configured and arranged to receive and process the intermediate frequency outputs of each of the plurality of aviation RF receiver front ends.

To facilitate such an approach, the outputs of the plurality of aviation RF receiver front ends can be multiplexed together to thereby form a group multiplexed output 208 which can then operably couple to a corresponding input of the aviation RF receiver back end. By one approach, this can comprise multiplexing the discrete received signal outputs for each of the aviation RF receiver front ends in frequency with one another.

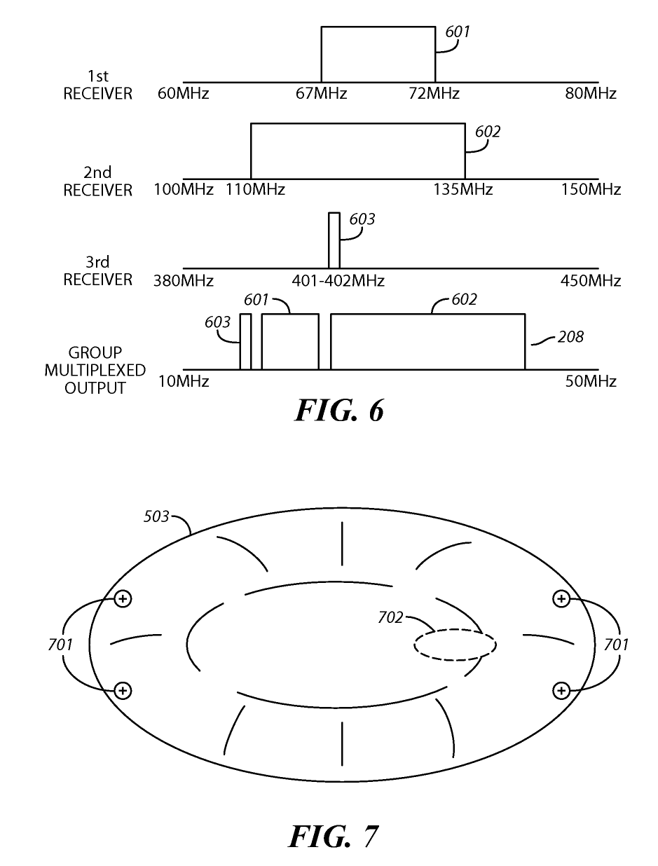

To illustrate with a simple example, and referring momentarily to FIG. 6, a first receiver can have a received signal band of interest 601 from 67 MHz to 72 MHz, a second receiver can have a received signal band of interest 602 from 110 MHz to 135 MHz, and a third receiver can have a received signal band of interest 603 from 401 MHz to 402 MHz. The aviation RF receiver front end for each such receiver can be programmed and configured to output its relevant intermediate frequency representation of those bands of interest such that, when combined into a combined group output 208, those bands of interest are multiplexed in frequency with one another and do not unduly overlap with or interfere with one another. (Those skilled in the art will recognize that the foregoing example is intended to serve only in an illustrative capacity and is not intended to comprise an exhaustive presentation in this regard or to otherwise serve as a limitation by example. It will be particularly understood that essentially any number of such bands of interest can be multiplexed in this manner.)

By this approach, a single aviation RF receiver back end 207 can receive such a group multiplexed output 208 and then de-multiplex the content to individually process, as appropriate, each band of interest. As shown in FIG. 5, this group multiplexed output 208 can pass through a corresponding hole 209 or other portal mechanism in the fuselage 206. By one approach this group multiplexed output 208 can comprise an electrical conductor such as, but not limited to, a coaxial cable or the like.

Referring again to FIG. 1, these teachings will then provide for provision 104 of an external covering that is at least partially permeable to RF signals and that will provide at least a substantial barrier against external moisture and objects. As used herein, it will be understood that the expression “external covering” refers to a covering that is configured and arranged to be disposed, at least in part, in a fixed position proximal to an exterior surface of an aircraft by either being disposed, at least in part above that exterior surface of the aircraft or by being mounted substantially flush to that exterior surface. The aforementioned antenna(s) and/or aviation RF receiver front end(s) may then be suitably configured and arranged to be deployed and fixed in place, external to the aircraft fuselage, underneath this external covering. An illustrative example of such a configuration appears in FIG. 5, where the latter two component structures 501 and 502 are mounted external to the aircraft fuselage 206 underneath such an external covering 503. By another approach, these latter component structures 501 and 502 can be located within the aircraft fuselage 206, though very proximal to the fuselage wall itself (for example, by being mounted on and in contact with that fuselage wall).

This external covering 503 can be aerodynamically configured and arranged to avoid presenting undue wind resistance as the aircraft moves through the atmosphere. By one approach, as suggested by both FIGS. 5 and 7, this external covering can have an aircraft-radome shape (comprising, in this particular illustrative embodiment, a low-profile, tapered-edge, oval) that can be secured to the aircraft fuselage using screws 701 or other attachment mechanisms of choice. These teachings will also accommodate using a seal (not shown) of choice between the external covering 503 and the fuselage 206 to further aid with respect to protecting the antenna(s) 501 and/or the aviation RF receiver front end(s) 502 from harm due to moisture, objects, or the like.

If desired, this external covering 503 can itself further serve to assist with electro/magnetically isolating one antenna from another. With this in mind, for example, the external covering 503 can itself be comprised of a dielectric material (or materials) of choice. With this in mind, the external covering 503 can then have one or more portions 702 thereof that are configured and arranged to have different frequency selective permeability characteristics that can in turn be leveraged to aid with the aforementioned isolation. As one example in this regard, the external covering 503 can have one or more portions 702 of varying thickness to thereby provide differing quantities of the dielectric material comprising the external covering 503 in close proximity to certain of the antennas. As another example in this regard, the external covering 503 can have one or more portions 702 that exhibit variations with respect to its material composition to thereby affect the relative amount or characteristics of the dielectric material that is proximal to a given antenna. As yet another example in this regard, such portions 702 can also vary with respect to a coating that is disposed on the external covering 503 (either on the exterior and/or interior surface of that external covering 503). Those skilled in the art will appreciate and recognize that the use of such examples is intended to serve only in an illustrative fashion and that these examples are not intended to serve as exhaustive or otherwise limiting examples in this regard.

By one approach, these teachings permit the placement of densely packed antennas and their corresponding radios to be placed, in whole or in part, proximal to an exterior surface of an aircraft. In many application settings, of course, such an approach may result in a placement of these components in a location that is not necessarily readily accessible to a pilot, co-pilot, navigator, or other crew member. In this case, if desired, these teachings will readily support coupling one or more outputs of the aviation RF receiver back end 207 to one or more user interfaces 209 that are installed and located in the aircraft's cockpit 210 to thereby render that information in usable form conveniently to relevant crew members. Such a user interface 209 might comprise, for example, a pixilated display (not shown) that provides the received information in graphical form to an onlooker. Various such user interfaces are well known in the art and others are likely to be developed going forward. As these teachings are not particularly sensitive to the selection of any particular approach in this regard, for the sake of brevity further elaboration regarding such components will not be provided here.

By one approach, the aforementioned components can be powered by electricity that is delivered via an electrical conductor. This, of course, comprises a typical approach that would well accord with prior art practice in this regard. It would also be possible, however, to power such components by delivering light (via, for example, a light carrying pathway such as optical fiber) to or near the component and then converting that light into electricity. Examples of such an approach in an aviation context can be found in the following pending U.S. patent applications, the contents of which are fully incorporated herein by this reference:

Apparatus and Method Pertaining to Light-Based Power Distribution in a Vehicle filed on Oct. 16, 2006 and having application Ser. No. 11/549,887;

Apparatus and Method Pertaining to Light-Based Power Distribution in a Vehicle filed on Oct. 16, 2006 and having application Ser. No. 11/549,891;

Apparatus and Method Pertaining to Provision of a Substantially Unique Aircraft Identifier Via a Source of Power filed on Oct. 16, 2006 and having application Ser. No. 11/549,899; and

Apparatus and Method Pertaining to Light-Based Power Distribution in a Vehicle filed on Oct. 16, 2006 and having application Ser. No. 11/549,904.

It would also be possible to convey the aforementioned output of the aviation RF receiver back end 207 to, for example, one or more user interfaces 209 using an electricity-conveying pathway (such as copper wiring) and a corresponding signaling protocol of choice. In this case, however, it would also be possible to convey such data using one or more modulated light carriers. Examples of such an approach in an aviation context can be found in the following pending U.S. patent applications, the contents of which are fully incorporated herein by this reference:

Method and Apparatus for Handling Data and Aircraft Employing Same filed on Aug. 14, 2006 and having application Ser. No. 11/464,291;

Method and Apparatus for Handling Data and Aircraft Employing Same filed on Aug. 14, 2006 and having application Ser. No. 11/464,308; and

Method and Apparatus for Handling Data and Aircraft Employing Same filed on Aug. 14, 2006 and having application Ser. No. 11/464,321.

Those skilled in the art will recognize that a wide variety of modifications, alterations, and combinations can be made with respect to the above described embodiments without departing from the spirit and scope of the invention, and that such modifications, alterations, and combinations are to be viewed as being within the ambit of the inventive concept. As but one of many examples in this regard, these teachings will encompass the use of a plurality of group multiplexed outputs as described above. To illustrate, in a given embodiment there could be, say, ten aviation RF receiver front ends and two aviation RF receiver back ends with each of the aviation RF receiver back ends serving as the back end section of five different aviation-purposed platforms. In such a case, these teachings will readily accommodate a first group multiplexed output that couples the IF outputs of five of the aviation RF receiver front ends to a first one of the aviation RF receiver back ends and a second group multiplexed output that couples the IF outputs of the remaining aviation RF receiver front ends to the second aviation RF receiver backend.

We claim:

1. An apparatus comprising:
a plurality of aviation radio frequency receiver front ends, wherein each of the plurality of aviation radio frequency receiver front ends has a unique intermediate frequency received signal output;
a group multiplexed output operably coupled to each of the intermediate frequency received signal outputs such that the group multiplexed output comprises discrete received signal outputs for each of the plurality of aviation radio frequency receiver front ends as multiplexed in frequency with one another.

2. The apparatus of claim 1 wherein the plurality of aviation radio frequency receiver front ends are each configured and arranged to receive radio frequency signals for a corresponding different radio frequency platform.

3. The apparatus of claim 2 wherein at least some of the different radio frequency platforms each correspond to a different aviation operational purpose.

4. The apparatus of claim 3 wherein the different aviation operational purposes comprise at least one of:
global positioning system information reception;
two-way voice communications;
marker beacon reception;
omni-directional radio range reception;
aircraft transponder exchanges;
an Instrument Landing System (ILS) receiver comprised of a localizer receiver and a glideslope receiver;
a VHF Omni-directional Range (VOR) receiver;
an aircraft emergency locator transmitter (ELT);
an aircraft satellite communications receiver (SatCom);
a Traffic Alert Collision Avoidance System (TCAS) receiver;
an Automatic Dependent Surveillance-Broadcast (ADS-B) receiver;
a data link weather receiver;
a cellular telephony transceiver;
a satellite-based commercial broadcast receiver.

5. The apparatus of claim 1 wherein at least some of the plurality of aviation radio frequency receiver front ends have intermediate frequency received signal outputs of different bandwidths.

6. The apparatus of claim 1 wherein the plurality of aviation radio frequency receiver front ends comprises at least three aviation radio frequency receiver front ends.

7. The apparatus of claim 1 wherein the plurality of aviation radio frequency receiver front ends comprises at least six aviation radio frequency receiver front ends.

8. The apparatus of claim 1 wherein the plurality of aviation radio frequency receiver front ends comprises at least twelve aviation radio frequency receiver front ends.

9. The apparatus of claim 1 wherein the plurality of aviation radio frequency receiver front ends are configured and arranged to be installed and disposed at least partially external to an aircraft fuselage.

10. The apparatus of claim 1 further comprising:
a plurality of antennas, wherein one of each of the plurality of antennas operably couples to a single one of the plurality of aviation radio frequency receiver front ends to provide received signals thereto.

11. The apparatus of claim 10 wherein:
the plurality of aviation radio frequency receiver front ends are configured and arranged to be installed and disposed proximal to the aircraft fuselage;
the plurality of antennas are configured and arranged to be installed and disposed at least partially external to an aircraft fuselage and in close physical proximity to the plurality of aviation radio frequency receiver front ends.

12. The apparatus of claim 11 further comprising:
an external covering that is at least partially permeable to radio frequency signals and that will provide at least a substantial barrier against external moisture and objects, and wherein the external covering is configured and arranged to be disposed, at least in part, in a fixed position above the plurality of aviation radio frequency receiver front ends and the plurality of antennas.

13. The apparatus of claim 12 wherein the external covering is aircraft-radome shaped.

14. The apparatus of claim 12 wherein the external covering has portions thereof that are configured and arranged to have different frequency selective permeability characteristics to thereby aid in electro/magnetically isolating at least one of the antennas from another of the antennas.

15. The antenna array of claim 14 wherein the external covering has portions thereof that are configured and arranged to have different frequency selective permeability characteristics as a function, at least in part, of at least one of:
variations with respect to relative thickness of the portions of the external covering;
variations with respect to material composition of the portions of the external covering;
variations with respect to a coating disposed on the external covering.

16. The apparatus of claim 1 further comprising:
an aviation radio frequency receiver back end having an input that is configured and arranged to receive the group multiplexed output.

17. The apparatus of claim 16 wherein the aviation radio frequency receiver back end is further configured and arranged to de-multiplex the group multiplexed output to thereby facilitate further processing and demodulation of content as received by each of the plurality of aviation radio frequency receiver front ends.

18. The apparatus of claim 16 wherein the aviation radio frequency receiver back end is further configured and arranged to be installed and disposed physically proximal to the plurality of aviation radio frequency receiver front ends.

19. The apparatus of claim 16 further comprising at least one of an electrical signal pathway and an optical pathway that is configured and arranged to couple the group multiplexed output to the aviation radio frequency receiver.

20. A method comprising:
providing a plurality of aviation radio frequency receiver front ends, wherein each of the plurality of aviation radio frequency receiver front ends has an intermediate frequency received signal output;
providing a group multiplexed output operably coupled to each of the intermediate frequency received signal outputs such that the group multiplexed output comprises discrete received signal outputs for each of the plurality of aviation radio frequency receiver front ends as multiplexed in frequency with one another.

21. The method of claim 20 wherein the plurality of aviation radio frequency receiver front ends are each configured and arranged to receive radio frequency signals for a corresponding different radio frequency platform.

22. The method of claim 21 wherein at least some of the different radio frequency platforms each correspond to a different aviation operational purpose.

23. The method of claim 22 wherein the different aviation operational purposes comprise at least one of:
global positioning system information reception;
two-way voice communications;
marker beacon reception;
omni-directional radio range reception;
aircraft transponder exchanges;
an Instrument Landing System (ILS) receiver comprised of a localizer receiver and a glideslope receiver;
a VHF Omni-directional Range (VOR) receiver;
an aircraft emergency locator transmitter (ELT);
an aircraft satellite communications receiver (SatCom);
a Traffic Alert Collision Avoidance System (TCAS) receiver;
an Automatic Dependent Surveillance-Broadcast (ADS-B) receiver;
a traffic avoidance receiver (TCAS/ADS-B);
a data link weather receiver;
a CDMA cellular phone telephony transceiver;
a satellite-based commercial broadcast radio receiver.

24. The method of claim 20 wherein at least some of the plurality of aviation radio frequency receiver front ends have intermediate frequency received signal outputs of different bandwidths.

25. The method of claim 20 wherein the plurality of aviation radio frequency receiver front ends comprises at least three aviation radio frequency receiver front ends.

26. The method of claim 20 wherein the plurality of aviation radio frequency receiver front ends comprises at least six aviation radio frequency receiver front ends.

27. The method of claim 20 wherein the plurality of aviation radio frequency receiver front ends comprises at least twelve aviation radio frequency receiver front ends.

28. The method of claim 20 wherein providing a plurality of aviation radio frequency receiver front ends comprises providing a plurality of aviation radio frequency receiver front ends that are configured and arranged to be installed and disposed proximal to the aircraft fuselage.

29. The method of claim 20 further comprising:
providing a plurality of antennas, wherein one of each of the plurality of antennas operably couples to a single one of the plurality of aviation radio frequency receiver front ends to provide received signals thereto.

30. The method of 29 wherein:
the plurality of aviation radio frequency receiver front ends are configured and arranged to be installed and disposed proximal to the aircraft fuselage;
the plurality of antennas are configured and arranged to be installed and disposed proximal to the aircraft fuselage and in close physical proximity to the plurality of aviation radio frequency receiver front ends.

31. The method of claim 30 further comprising:
providing an external covering that is at least partially permeable to radio frequency signals and that will provide at least a substantial barrier against external moisture and objects, and wherein the external covering is configured and arranged to be disposed, at least in part, in a fixed position above the plurality of aviation radio frequency receiver front ends and the plurality of antennas.

32. The method of claim 20 further comprising:
providing an aviation radio frequency receiver back end having an input that is configured and arranged to receive the group multiplexed output.

33. The method of claim 32 wherein the aviation radio frequency receiver back end is further configured and arranged to de-multiplex the group multiplexed output to thereby facilitate further processing and demodulation of content as received by each of the plurality of aviation radio frequency receiver front ends.

34. An aircraft comprising:
a fuselage;
a plurality of aviation radio frequency receiver front ends installed and disposed, at least in part, closely proximal to the fuselage and wherein each of the plurality of aviation radio frequency receiver front ends has an intermediate frequency received signal output;
a group multiplexed output operably coupled to each of the intermediate frequency received signal outputs such that the group multiplexed output comprises discrete received signal outputs for each of the plurality of aviation radio frequency receiver front ends as multiplexed in frequency with one another.

35. The aircraft of claim 34 wherein:
the fuselage has an opening therethrough configured and arranged to accommodate a signal pathway;
the plurality of aviation radio frequency receiver front ends are installed and disposed, at least in part, exterior to the fuselage and wherein each of the plurality of aviation radio frequency receiver front ends has an intermediate frequency received signal output;
the group multiplexed output passes through the opening in the fuselage.
